(19) United States
(12) Patent Application Publication
(10) Pub. No.: US 2016/0319580 A1
(43) Pub. Date: Nov. 3, 2016

(54) Mounting Device for a Door Panel

(71) Applicant: VAPOR EUROPE S.R.L. A WABTEC COMPANY, Sassuolo, (MO) (IT)

(72) Inventor: Alois Ritt, Amstetten (AT)

(21) Appl. No.: 15/107,571

(22) PCT Filed: Dec. 23, 2014
(86) PCT No.: PCT/EP2014/079252

§ 371 Date: Jun. 23, 2016

(30) Foreign Application Priority Data
Dec. 23, 2013 (EP) 13199487.3

(51) Int. Cl. E05D 15/06; B61D 19/02

(52) U.S. Cl. CPC E05D 15/0621; B61D 19/02

(57) ABSTRACT

The invention relates to a mounting device for connecting a door panel to a door connection element, including a door panel mount connectable with the door connection element and having a support portion, and an attaching element, which is connectable with the door panel and is to be attached to the support portion of the door panel mount for mounting the door panel on the door panel mount. It is provided that the support portion of the door panel mount and the attaching element when being attached to one another together form a pivot joint for a pivotable connection of the door panel with the door connection element. The pivot joint defines a pivot axis and the attaching element is attachable to the support portion of the door panel mount in an attaching direction having a directional component vertical to the pivot axis.

The invention relates to a mounting device according to claim 1, to a method for mounting a door panel to a door connection element according to claim 14, to a door for a wagon according to claim 15 and to a wagon according to claim 16.

Mounting devices are used for mounting door panels to a door, e.g. to a door frame, or to a part of the structure the door is belonging to, such as a wall of a building or a wagon or vehicle. In particular, mounting devices are used to mount door panels of sliding doors or sliding plug doors to the door or to a part of the door being connected to the structure, such as a door drive device provided for opening and closing one or more door panels.

Sliding doors or sliding plug doors are often deployed in wagons of mass transportation vehicles. In a closed state, door panels of such doors cover a door opening defined by the door frame. For opening the door, the door panels have to be shifted sideways in order to clear the door opening, e.g. to allow passengers to board or alight the wagon through the door opening.

To compensate for production tolerances or deformations, e.g. of the door frame, of the door drive device, of the door panel itself or of other parts, and/or to align the door panel with its door frame, it is known to pivotably mount a door panel with respect to the wagon, i.e. to a door connection element, such as a door drive device or a part thereof.

It is also known to design door panels of wagons of mass transportation vehicles, such as busses, cars or railway or subway trains or the like, with varying shapes. E.g., door panels may have a substantially flat, planar shape or have a bent, curved or corrugated shape. Especially door panels of subway trains are often at least partially bent outwards, e.g. for efficiently using the available space in the subway tube.

With a mounting device providing a pivotable connection of the door panel to the door drive device, it is possible to apply the same door drive device (or in general the door connection element the door panel is connected with) and the same mounting device for doors with different shapes, e.g. with different curvatures and/or wagons in which the doors have to be installed at different angles.

EP 1 914 372 A2 describes a door of a mass transportation vehicle, being designed as a sliding door or as a sliding plug door. Therein, a door panel mount for mounting a door panel is pivotably connected to a carrying arm of a door drive by means of a hinge joint. A door panel mounted to the door panel mount may therefore pivot and swing about a pivot axis, which is located on the upper edge of the door panel and extends in parallel to the direction in which the door panel slides open and close.

However, the known pivotable connection of the door panel mount with a carrying arm has the disadvantage that it may require two or more persons for mounting the door panel. Moreover, the installation and adjustment of a door panel on the known pivotable door panel mount is complicated and may thus be time consuming.

The object of the invention is to provide a mounting device for a pivotable connection of a door panel mount to a door connection element, wherein it is possible to easily and quickly mount the door panel to the door connection element.

Said object is achieved by a mounting device, having the features of claim 1.

Such a mounting device for connecting a door panel to a door connection element comprises a door panel mount, which is connected or horizontally slideable on the door connection element (e.g. it is connectable with the door connection element) and which has a support portion. The mounting device further comprises an attaching element, which is connected or connectable with the door panel and which is to be attached to the support portion of the door panel mount for supporting the door panel on the door panel mount. It is provided that the support portion of the door panel mount and the attaching element when being attached to one another together form a pivot joint providing a pivotable connection of the door panel with the door connection element, wherein the pivot joint defines a pivot axis and the attaching element is attachable to the support portion of the door panel mount in an attaching direction having a directional component vertical to the pivot axis. Of course, the mounting device may be designed such that the attaching element is additionally also attachable to the support portion in an attaching direction which is substantially parallel to the pivot axis and has no directional component vertical to the pivot axis.

The mounting device may generally be used for mounting a door panel to a door, e.g. to a door frame, or to the structure or a part of the structure the door is belonging to, such as a wall of a building or a wagon or vehicle. In particular, the mounting device may be used for mounting a door panel to a wagon of a mass transportation vehicle, such as a bus, a subway, metro or railway train, an airplane, a cable car, a street car or the like; however, it may also be used e.g. in a car, in an elevator etc. Furthermore, the mounting device may particularly be used for connecting a door panel of a sliding door or a sliding plug door to the door connection element. Therein, the door connection element may e.g. be a door drive device, i.e. a part of a door drive device driving the door panel from a closed state into an opened state and vice versa.

In general, the mounting device may be used to mount the door panel to another part of the door or of the wagon or any other related part serving as a door connection element and being suitable to mount the door panel such that it may be operated to open and close the door opening in a conventional manner.

By means of the mounting device, the installation of a door panel may be particularly easy and carried out in a short time.

The pivot axis about which the door panel is pivotably supported may be aligned substantially parallel to the plane of the door panel and substantially horizontal with the mounting device being in use. However, the arrangement of the pivot axis is not limited to this configuration and may also be aligned in another way, e.g. substantially vertical. When the mounting device is mounted in a wagon, the pivot axis may particularly be aligned in parallel to the longitudinal extension of the wagon and/or parallel to the axis along which the door panel may be displaced for opening and closing the door. Moreover, the mounting device may be arranged in the region of an upper edge of the door panel, with the pivot axis extending adjacent and substantially along the upper edge of the door panel.

For acting as a pivot joint and enabling a pivoting of the door panel, the support portion of the door panel mount and/or the attaching element may have a substantially round or circular cross section or a cross section with a convex part. One of the two parts may partially encompass the other one of said two parts; therefore, one may be formed as a protrusion while the other is formed as a recess or a depression. Both parts may be formed such that they fit into one another allowing to be pivoted about the pivot axis with respect to one another. In this sense either the attaching element or the support portion of the door panel mount may be formed as a hook, while the respective other part may be formed such as to be engageable by the hook. When pivoting, the support portion of the door panel mount and the attaching element glide along one another. Alternatively, either the support portion of the door panel mount or the attaching element may be formed as a tip supporting or being supported by the respective other part.

A range within which the door panel is pivotable with respect to the door panel mount may be limited to a certain range, such as 15 degrees, 10 degrees or 5 degrees.

The support portion of the door panel mount may have an elongate shape. The attaching element may have a receptacle which also has an elongate shape and is adapted for receiving the support portion of the door panel mount. For attaching the attaching element to the support portion of the door panel mount, the support portion is aligned parallel to and at least partially inserted into the receptacle of the attaching element. In particular, the door panel may be connected with the door connection element by hanging the attaching element onto the support portion of the door panel mount by approaching both parts in a direction which is not parallel to their longitudinal extension. In other words, it is possible to hang the attaching element e.g. from above on the support portion of the door panel mount and it is not necessary to coaxially arrange the attaching element and the support portion of the door panel mount one besides the other and connect them by an axial relative displacement (i.e. in parallel to the pivot axis).

For a connection of the door panel being connected with the attaching element with the support portion of the door panel mount, the attaching element may simply be hung on said support portion such that the attaching element is held on the support portion by its own weight. To prevent a lift-off of the attaching element and thus of the door panel from the support portion of the door panel mount, a counterpart may be provided. Such a counterpart may be fixed to the door panel, e.g. by means of fastening elements, such as screws, rivets or the like.

The counterpart may be arranged adjacent to a part of the door panel mount, which is located on a side of the door panel mount opposite the support portion. Therefore, the counterpart may act as a clamp, which allows the door panel to be pivoted but hinders the door panel to be translated at least in one direction, e.g. in vertical direction. In other words, it is possible to secure the connection of the attaching element with the support portion of the door panel mount in a location being different from the support portion and the attaching element.

For allowing the door panel to be pivoted, the counterpart may comprise a gliding surface which may glide along a corresponding gliding surface of the door panel mount when the door panel is pivoted about the pivot axis. Alternatively, the counterpart may also hinder the door panel to pivot and serve for fixing the door panel in a given pivot position. Furthermore, the counterpart also may limit the angular range in which the door panel is pivotable.

The door panel mount may comprise a recess, which is engaged by a protrusion of the counterpart. The shape and/or depth of the recess and the shape and/or length of the protrusion (in direction of the depth of the recess) may limit the angular range in which the door panel may be pivoted with respect to the door panel mount.

The support portion of the door panel mount may be formed in one piece with the door panel mount or a part of the door panel mount. Also the attaching element may be formed in one piece with the door panel or a part of the door panel. Alternatively, the support portion may be formed as a component being separate from the door panel mount and/or the attaching element may be formed as a component being separate from the door panel.

While not being limited to this configuration, the attaching element may be arranged on an upper portion of the door panel, e.g. adjacent an upper edge of the door panel. The attaching element may be formed as a recess or receptacle with an opening facing downwards when being mounted as intended. Alternatively, the attaching element may be formed as a protrusion facing downwards when being mounted as intended. The attaching element may extend along a part of the width of the door panel or substantially along the whole width of the door panel. The supporting portion of the door panel mount may be formed correspondingly.

According to an aspect, the mounting device may further comprise an adjusting device, which serves for pivoting/swiveling the door panel about a swivel axis being substantially vertical to the plane of the door panel and which is thus substantially vertical to the pivot axis.

The adjusting device may comprise a bolt and an adjusting element, wherein the bolt engages an opening of the counterpart and the adjusting element engages an opening of the door panel. The adjusting element may then serve to adjust the distance of the bolt of the adjusting device and/or the opening in the counterpart to the opening of the door panel and/or to adjust the height of the door panel and/or to swivel the door panel.

The mounting device and/or the door panel and/or the wagon may comprise further elements by means of which the desired angular position of the door panel may be fixed. For example, a guide rail may be provided on a lower part of the door panel, which may be slidably engaged with a runner hindering the door panel to pivot.

The object is also achieved by a method for mounting a door panel to a door connection element, having the features of claim 14.

Therein, a door panel is mounted to a door connection element by means of a mounting device having a door panel mount being connected or is horizontally slideable on the door connection element (e.g. it connectable to the door connection element) and having a support portion. The mounting device further has an attaching element being connected or connectable with the door panel and being connectable with the support portion of the door panel mount for mounting the door panel on the door panel mount. It is provided that the attaching element is attached to the support portion of the door panel mount in an attaching direction, wherein the support portion of the door panel mount and the attaching element when being attached to one another together form a pivot joint for a pivotable connection of the door panel with the door connection element, wherein the pivot joint defines a pivot axis having a directional component vertical to the attaching direction.

The method may further include the step of pivoting the door panel into a desired angular position with respect to the door panel mount, wherein the door panel is pivotable by means of the pivot joint formed by the connection of the support portion of the door panel mount and the attaching element. Afterwards, the angular position the door panel may be fixed by suitable means; however, it is also possible to allow the door panel to be pivoted in a certain range also in use.

The method for mounting a door panel to a door connection element may be adapted for mounting the mounting device according to any aspect or embodiment described herein, as well as any combination of aspects and/or embodiments described herein. In particular, the method may include to secure the connection of the attaching element and the support portion of the door panel mount by means of a counterpart as described herein.

According to another aspect of the invention, a door for a wagon is provided, comprising at least one mounting device according to any embodiment and aspect described herein as well as to any combination of aspects and/or embodiments described herein.

According to another aspect of the invention, a wagon is provided, comprising at least one mounting device according to any embodiment and aspect described herein as well as to any combination of aspects and/or embodiments described herein.

Additional features and aspects of the invention will be explained in more detail in the following description of exemplary embodiments with reference to the accompanying figures, wherein:

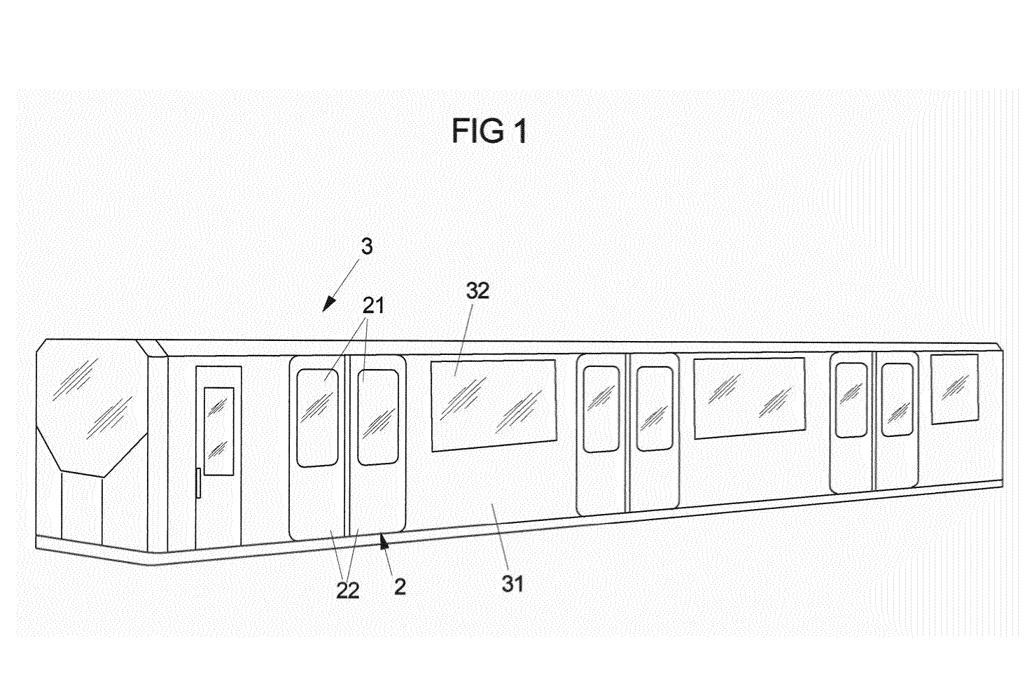

FIG. 1 shows a mass transportation vehicle comprising several sliding plug doors,

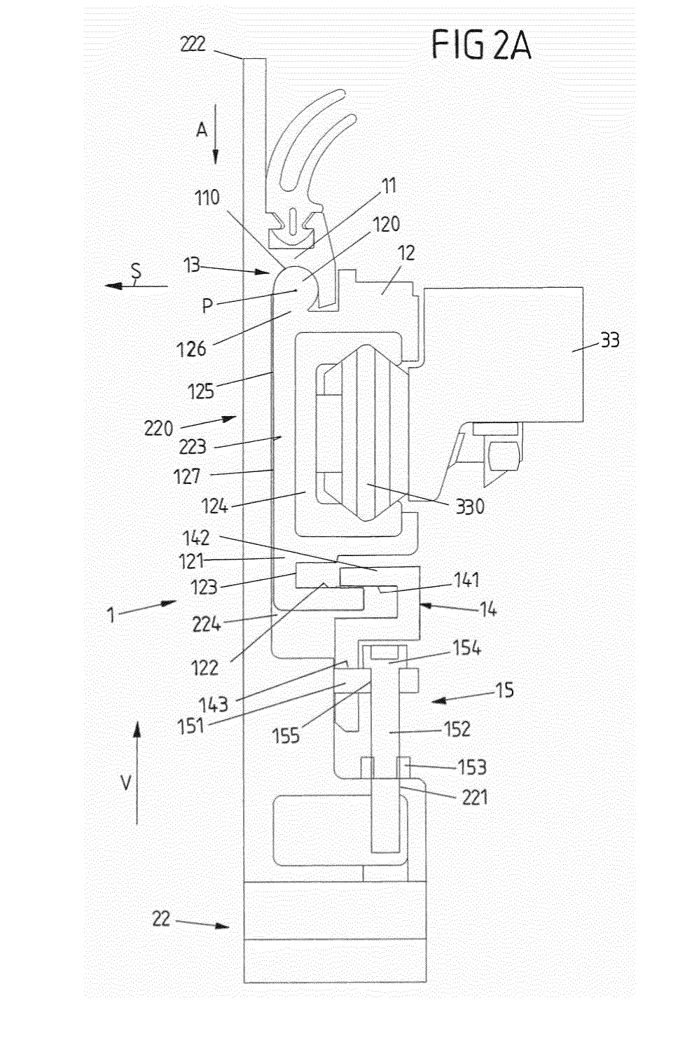

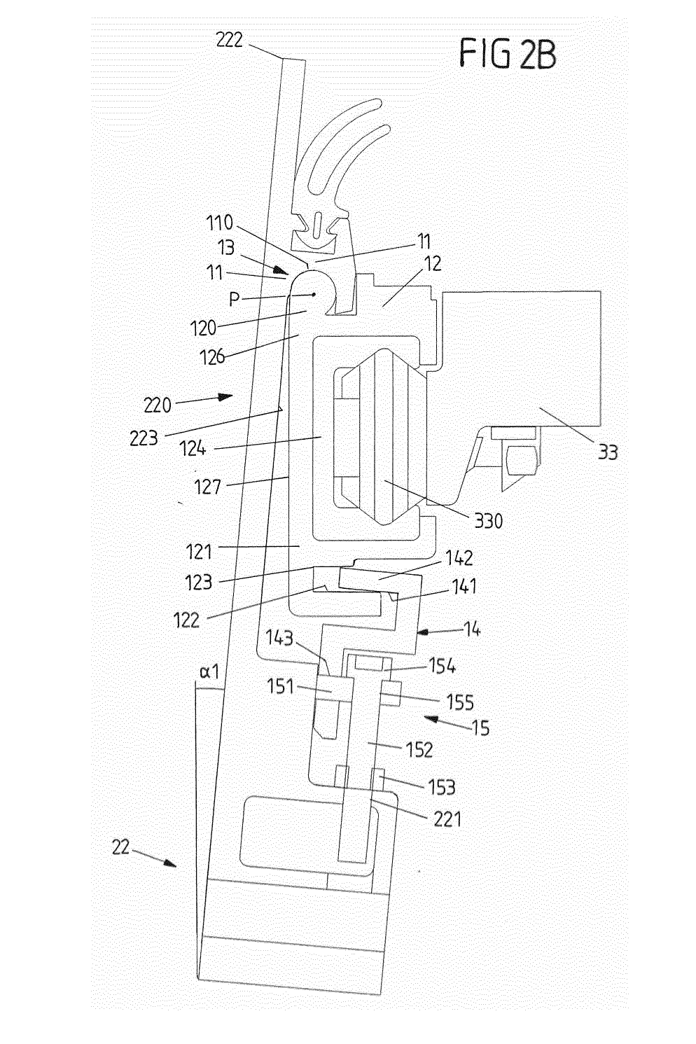

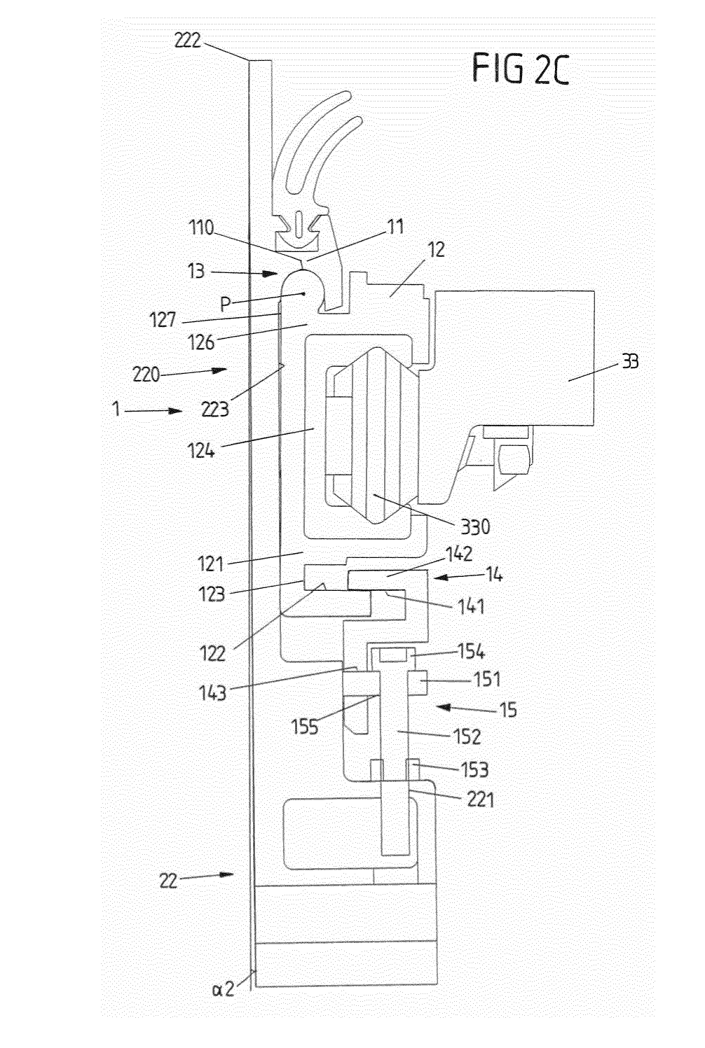

FIG. 2A shows a cross section of an upper part of a door panel mounted to a door

FIG. 2B shows the cross section of the upper part of the door panel according to FIG. 2A after pivoting the door panel clockwise,

FIG. 2C shows the cross section of the upper part of the door panel according to FIG. 2A after slightly pivoting the door panel counter-clockwise,

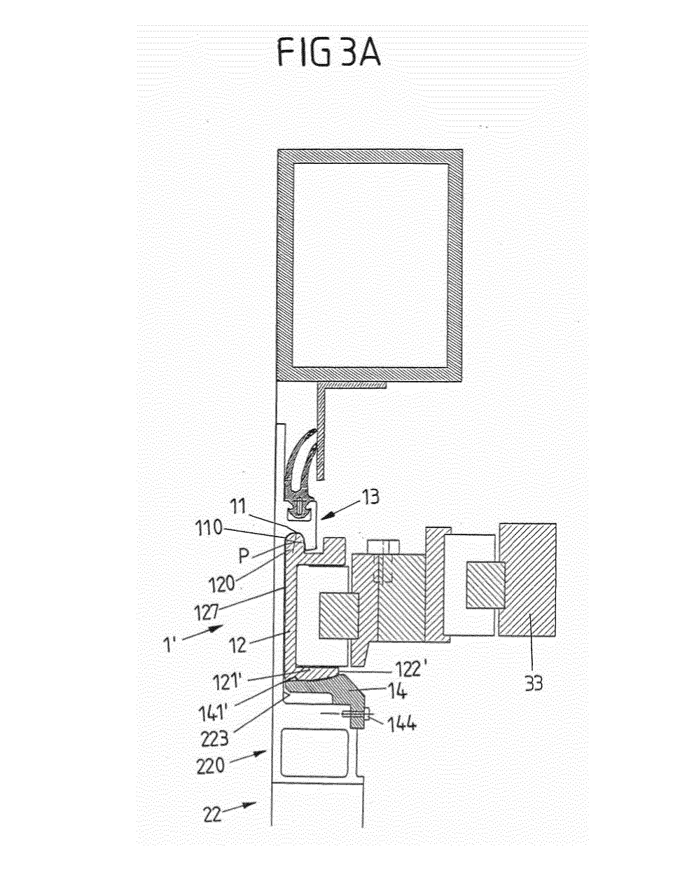

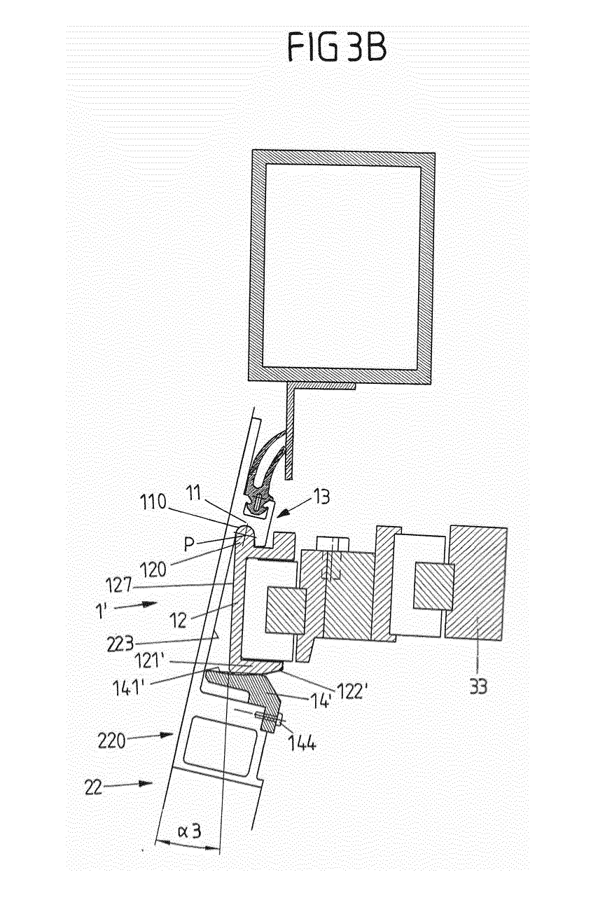

FIG. 3A shows a cross section of an upper part of a door panel mounted to a door panel mount by means of a mounting device according to another embodiment, and

FIG. 3B shows the cross section of the upper part of the door panel according to FIG. 3A after slightly pivoting the door panel clockwise.

FIG. 1 shows a wagon 3 of a mass transportation vehicle comprising a wagon body 31, wagon windows 32 and several doors 2. The doors 2 of the wagon 3 will be described in greater detail with reference to the following figures.

The wagon 3 of FIG. 1 is a wagon 3 of a mass transportation vehicle, in particular of a metro train, and serves as an example for all other mass transportation vehicles, such as railway trains, busses, airplanes, cable cars, street cars, and others.

Mass transportation vehicles, such as the mass transportation vehicle having a wagon 3 as shown in FIG. 1, are boarded and alighted through doors. Often, sliding plug doors are used for such vehicles, such as the doors 2 in FIG. 1, but also sliding doors, plug doors, swing doors and other types of door systems are known. The doors 2 may be any of these door types.

When being in a closed position, many sliding plug doors of mass transportation vehicle wagons, as the doors 2 in FIG. 1, do not project from the side surface of the wagon body 31. When the doors 2 are moved in an opened position, this movement may be mainly divided in two parts: first the doors 2 are moved outwards, i.e. in a direction substantially vertical to the surfaces of the doors 2. Then, the doors 2 are shifted sideways in an opened position to clear the doorframe. When the doors 2 are closed, they are moved back from an opened position into a closed position, wherein the same partial movements are executed, just in reversed order. In other embodiments doors may also be mounted such that they do not flush with the side surface of the corresponding wagon body. In the closed state such doors slightly project from the side surface of the wagon body. When being opened and closed, such doors only have to be shifted sideways without being moved outwards before and inwards afterwards, respectively. For an optimum fit of the doors 2 in or on the doorframe and a smooth opening and closing movement, the doors 2 may be adjusted during installation by pivoting about one or more pivot axes.

The doors 2 of the wagon 3 comprise two door panels 22 and for each door panel 22 a mounting device 1. Therefore, the door panels 22 may be mounted and/or demounted to/from the door 2 of the wagon 3 in a time-efficient manner and/or by only one person. Mounting the doors panels 22 includes attaching the door panels 22 to a door connection element, e.g. a door-carrying device, a guiding means, support mechanism or a door drive, adjusting the door panels 22, and securing the door panels 22.

There are wagons that only comprise one door. However, usually, wagons 3 of mass transportation vehicles comprise more than one door 2. For example, a wagon 3 may comprise two, three, four or more doors 2 on either side of the wagon 3. Often, doors of wagons of mass transportation vehicles are constructed as double doors. Eventually, the wagons may comprise one or more additional doors for a driver. In some wagons, there are also doors inside the wagon. In some types of mass transportation vehicles, one or more doors connect each two wagons of the vehicles. For all such doors, doors 2 comprising a mounting device 1 may be used.

FIG. 2A-2C show an embodiment of a mounting device 1 for mounting a door panel 22 to a wagon 3, i.e. to a part of the wagon 3. In FIG. 2A-2C the door panel 22 is mounted to a door connection element in the form of a carrier 33, which itself is fixedly or displaceably mounted on the wagon 3 via a connection not shown in the figures.

The mounting device 1 comprises a door panel mount 12 which is displaceably connected to said carrier 33 by means of a guide rail 124 fixedly connected with the door panel mount 12 and supporting one or more rolling elements 330 rotatably arranged on the carrier and engaging the guide rail 124, wherein in the cross-sectional views of FIG. 2A-2C only one rolling element 330 designed as a roller is visible.

On an upper portion 126 of the door panel mount 12 a support portion 120 is arranged. In the illustrated embodiment the support portion 120 is integrally formed in one piece with the door panel mount 12 but it may alternatively also be formed as a separate piece and connected with the door panel mount 12 in a suitable manner, e.g. by fastening elements or by a form-locking connection with the door panel mount 12. The support portion 120 is elongate and has a substantially circular cross-sectional shape and extends along the axis of sight in FIG. 2A-2C, i.e. substantially parallel to an upper edge 222 of the door panel 22 mounted to the door panel mount 12. Therein, the support portion 120 may either extend along the whole or a major part of the width of the door panel 22, i.e. along the upper edge 222 of the door panel 22 or it may extend only over one or more (e.g. at least two) sections of said width. Moreover, the cross section and/or the cross-sectional shape of the supporting element 120 may be substantially the same along the width of the door panel 22 or may alternatively vary along the width of the door panel 22.

The support portion 120 of the door panel mount 12 is inserted into and brought into contact with an elongate attaching element 11, i.e. with an elongate receptacle 110 of the attaching element 11, which is formed on an upper portion 220 of the door panel 22. The receptacle 110 of the attaching element 11 has an inner surface with approximately the same cross-sectional shape as an outer surface of the support portion 120 of the door panel mount 12 in the region where said outer surface contacts said inner surface. As can be seen in FIG. 2A-2C, in cross section the receptacle 110 of the attaching element 11 is formed in a U-shape opening downwards. Therefore, the supporting element 120 of the door panel mount 12 fits into the receptacle 110 of the attaching element 11 and serves as a support for the attaching element 11 and thus for the door panel 22. In addition to the function of supporting the door panel 22, the attaching element 11 and the support portion 120 of the door panel mount 12 are formed such that they form a pivot joint 13 when being attached to one another, as e.g. shown in FIG. 2A-2C. Therefore, the door panel 22 may be pivoted about a pivot axis P (extending along the axis of sight in FIG. 2A-2C) formed by the pivot joint 13. The inner surface of the receptacle 110 of the attaching element 11 may roll off and/or glide along the outer surface of the support portion 120 of the door panel mount 12, when the door panel 22 is being pivoted about the pivot axis P.

In the embodiment depicted in FIG. 2A-2C the attaching element 11 is formed as a hook which can be hooked on the support portion 120 of the door panel mount 12 such that it partly encompasses said support portion 120. Therein, the receptacle 110 of the attaching element is formed such that the width of its opening equals or is greater than the cross section of the support portion 120 of the door panel mount 12. Therefore, the attaching element 11 may be connected with the support portion 120 of the door panel mount 12 along an attaching direction A shown in FIG. 2A or another direction having a directional component vertical to the pivot axis P.

It is noted that the receptacle 110 of the attaching element 11 may or may not be open at its lateral ends (which are not visible in FIG. 2A-2C). When the lateral ends of the receptacle 110 are closed, e.g. an undesired shifting of the door panel 22 along its width (i.e. along the axis of sight in FIG. 2A-2C) is prohibited or limited to a certain range. However, when the lateral ends of the receptacle 110 are opened, the attaching element 11 may also be mounted to the support portion 120 of the door panel mount 12 in such a way, that it is first aligned in parallel and coaxially with said support portion 120 and then axially slid over the support portion 120. In the latter case, the resulting attaching direction is aligned parallel to the pivot axis P, i.e. has no directional component vertical to the pivot axis P.

FIG. 2B and 2C show the door panel 22 attached to the carrier 33 by means of the mounting device 1 of FIG. 2A, wherein the door panel 22 is shown in pivoted positions with respect to the position shown in FIG. 2A.

In FIG. 2B the door panel 22 has been pivoted clockwise by an angle α1 of about 6 degrees with respect to the position of the door panel 22 shown in FIG. 2A, where the door panel 22 is arranged substantially vertical. In FIG. 2C the door panel 22 has been pivoted counterclockwise slightly by an angle α2 of about 1 degree. A vertical axis V is depicted in FIG. 2A for the ease of reference.

Pivoting the door panel 22 counterclockwise is possible due to a small play 125 between an outer surface 127 of the door panel mount 12 and an opposing inner surface 223 of the door panel 22 due to a slight depression in said inner surface 223. This play 125 could also be created and/or increased e.g. by displacing the support portion 120 of the door panel mount 12 slightly in direction of the outer surface of the door panel 22, i.e. to the left in FIG. 2A, such that it slightly projects from the outer surface 127 of the door panel mount 12.

It is possible to fix the position of the door panel 22 after pivoting it into a given position, e.g. the position shown in FIG. 2B. Suitable fastening elements which are not shown in FIG. 2A-2C may be provided for this purpose and applied on the upper portion 220 of the door panel 22. It is not necessary to arrange such fastening elements on the attaching element 11 and/or the support portion 120 of the door panel mount 12. Additionally or alternatively, the door panel may be fixed in its angular position in a lower portion of the door panel not shown in FIG. 2A-2C.

Depending on the design and type of wagon to which the door panel 22 is mounted by means of the mounting device 1 the shape of its wagon body may significantly vary. For example, the side walls of a wagon body may be substantially planar and vertical, such as in the wagon 3 shown in FIG. 1. In other types of wagons the side walls are, e.g., inclined, curved or bent outwards with the outer surface of the door panels substantially following the outer shape of the wagon in the location where the door panel is mounted. By means of a pivotable connection of the door panel with a door connection element (such as the carrier 33) the same mounting device 1 may be used for mounting door panels to the door of the wagon.

When mounting the door panel 22 (or a different door panel) to the carrier 33 (or another door connection element) by means of the mounting device 1, the door panel 22 may first be hung on the support portion 120 of the door panel mount 12 by means of the attaching element 11. Next, the door panel 22 may be pivoted about the pivot axis P into a desired angular position, e.g. such as to flush with the part of the wagon body 31 surrounding the door 2 or a door frame enclosing one or more door panels 22. Then the door panel 22 may be fixed in its angular position; however, it is also conceivable, that in use, e.g. when opening and closing the door 2 and thus the door panel 22, the door panel 22 is being pivoted about the pivot axis P.

Allowing the door panel 22 to at least slightly pivot about the pivot axis P during use may reduce the tension between the door panel 22 and other parts of the door 2 or the mounting device 1. The door 2 having the door panel 22 shown in FIG. 2A-2C is a sliding plug door, i.e., starting from a closed position, before sliding the door panel 22 sideways to clear the door frame the door panel 22 is displaced in a direction vertical to the plane of the door panel 22. This displacement is carried out by a plug mechanism driving the carrier 33. Due to the inertia of the door panel 22 mass, the door panel 22 may be tensioned between the upper portion 220 and lower portions. Due to the pivotable connection of the door panel 22 with the carrier 33 lower portions of the door panel 22 are allowed to lag behind and follow the displacement of the upper portion 220, as shown in FIG. 2C, resulting in a reduced tensioning and stress of the door panel 22.

For hindering the door panel 22 to lift off from its support on support portion 120 of the door panel mount 12, the mounting device 1 shown in FIG. 2A-2C comprises a counterpart 14. After hanging the door panel 22 on the door panel mount 12 the counterpart 14 is fixed on the upper portion 220 of the door panel 22 adjacent to a lower portion 121 of the door panel mount 12. In the mounting device 1 shown in FIG. 2A-2C, the counterpart 14 is formed as a hook-shaped bar extending along the width of the door panel 22 and has a protrusion 142 engaging a recess 123 of the door panel mount 12 in the shape of a tongue-and-groove connection. By mounting the counterpart 14 to the door panel 22 and the door panel mount 12, the door panel 22 may no longer be lifted off the door panel mount 12, because the counterpart 14 abuts against the lower portion 121 of the door panel mount 12. However, due to the shape of the protrusion 142 of the counterpart 14 and the recess 123 of the door panel mount 12 the door panel 22 may still be pivoted about the pivot axis P defined by the pivot joint 13 in a certain range, defined by the depth of the recess 123 and the shape of the door panel mount 12 and the upper part 220 of the door panel 22 (if not otherwise hindered as described above).

Instead of having a hook-shaped cross section as shown in FIG. 2A-2C, the counterpart 14 may also be designed in another shape, e.g. with an L-shaped cross section.

For demounting the door panel 22 from the door panel mount 12, the counterpart 14 may be removed from the mounting device 1. The attaching element then removably rests on the support portion 120 of the door panel mount 12. Below the lower portion 121 of the door panel mount and the door panel 22 there is a play 224 allowing to lift the door panel 22 with the attaching element 11 upwards substantially along the vertical axis V in order to bring the attaching element 11 and the support portion 120 of the door panel mount 12 out of engagement. Then the door panel 22 may be removed from the door panel mount in a direction substantially vertical to the plane of the door panel 22. For mounting the door panel 22 to the door panel mount 12 the same steps may be performed in reverse order.

For an adjustment of the position of the door panel 22 within the door 2 or a door frame of the door 2, e.g. to compensate production and/or mounting tolerances of parts of the mounting device 1, the door 2 or the wagon 3, it may be necessary not only to pivot the door panel 22 about the pivot axis P but also to swivel the door panel 22 about a swivel axis S illustrated in FIG. 2A and being substantially vertical to the pivot axis P and substantially vertical to the plane of the door panel 22. For this purpose the mounting device 1 shown in FIG. 2A-2C comprises an adjusting device 15 having an adjusting element 152 designed as a screw, and a bolt 151 being inserted into a corresponding opening 143 of the counterpart 14. The adjusting element 152 is inserted into an opening 155 in the bolt 151 and abuts the bolt 151 with its screw head 154.

The door panel 22 may be pivoted by means of the adjusting device 15 by screwing the adjusting element 152 in an opening 221 in the door panel 22 which has an inner thread engaged by an outer thread of the adjusting element 152. Of course also a corresponding screw nut could be arranged on one or both sides of the opening 221 of the door panel 22 instead and also other types of an adjusting element 152 may be used instead of a screw. When the adjusting element 152 is adjusted, i.e. in the present case, when it is screwed into the opening 221 of the door panel 22, the distance between the opening 221 and the screw head 154 is shortened and thus the door panel 22 is lifted correspondingly, i.e. in the instant case, substantially vertically. The adjusting device 15 is arranged close to a side edge of the door panel 22 but of course it may also be arranged elsewhere along the width of the door panel 22. Moreover, also more than one adjusting device may be provided and arranged in different locations along the width of the door panel 22. A counter nut 153 secures the position of the adjusting element 152.

The counterpart 14 is contacts a contact surface or gliding surface 122 of the lower portion 121′ of the door panel mount 12 with a contact surface or gliding surface 141. If the door panel 22 is not fixed in a certain angular position and thus pivotable in use, these gliding surfaces 122, 141 glide along one another while pivoting the door panel.

The mounting device 1 comprises fastening elements not shown in FIG. 2A-2C for fastening the counterpart 14 to the door panel 22 after swiveling the door panel 22 by means of one or more adjusting devices 15 (if such an adjustment is necessary).

It is noted that the attaching element 11 may either be formed in one piece with the upper portion 220 of the door panel 22 or it may also be formed as a separate piece and connected with the door panel 22 e.g. by means of fastening elements.

It is further noted that the supporting element 120 not necessarily has to have a circular form in cross section. For example, the cross-sectional form of the supporting element 120 may also be oval or have a tip or a depression or have another shape, as long as the supporting element 120 and the attaching element 11 form a pivot joint 13.

The door panel mount 12 may be displaced along the axis of sight in FIG. 2A-2C by means of the rolling elements 330 supported in the guide rail 124. Alternatively or additionally, other means may be provided for a displacement of the door panel mount 12 along said axis or along another axis, e.g. along an axis substantially vertical to the plane of the door panel 22. Instead of rollers also other rolling elements, such as balls, rolls or wheels may be used as rolling elements 330. The guide rail 124 may also be integrally formed in one piece with the door panel mount 12; alternatively, a guide rail may be formed on or attached to the carrier 33 with the rolling elements 330 then being arranged on the door panel mount 12.

Therefore, the door panel 12 is connectable with the door connection element 33, i.e. the door panel 12 is horizontal slideable on the door connection element 33 or displacably connected to the connection element 33 (or carrier).

FIG. 3A and 3B show a mounting device 1′ which is modified with respect to the mounting device 1 according to FIG. 2A-2C. Parts with substantially the same shape and/or function are addressed with like reference signs and it is referred to the above explanations with reference to FIG. 2A-2C for their description. In accordance with FIG. 2A and 2B, FIG. 3A and 3B show a door panel 22 before (FIG. 2A and 3A) and after (FIG. 2B and 3B) pivoting the door panel 22 clockwise. In FIG. 3B, the door panel 22 is pivoted about an angle α3 of approximately 10 degrees by means of the mounting device 1′ about the pivot axis P.

In contrast to FIG. 2A-2C, the mounting device 1′ according to FIG. 3A-3B has a door panel mount 12′ having a gliding surface 122′ on its lower portion 121′ and a counterpart 14′ having a gliding surface 141′. Both gliding surfaces 122′, 141′ are in contact with each other and upon pivoting the door panel 22 about the pivot axis P glide along one another. The cross-sectional shape of the gliding surfaces 122′, 141′ substantially corresponds to a section of a circle having a radius equaling the distance of the gliding surface to the location of the pivot axis P. The respective surface area of the elongate door panel mount 12′ therefore corresponds to a section of a circular cylinder, the respective surface area of the counterpart 14′ is formed correspondingly.

Therefore, the counterpart 14′ (which may be fastened to the door panel by means of fastening elements 144) hinders the door panel 22 to be lifted and eventually be removed from the door panel mount 12′ and at the same time allows to pivot the door panel 22, at least in a certain range. The range in which the door panel 22 is pivotable may be limited by means not shown in FIG. 2A-3B (further to the limitations by the shape of the attaching means 11, the door panel 22 and the door panel mount 12).

Of course also the mounting device 1′ according to FIG. 3A-3B may be provided with one or more adjusting devices 15.

It is also possible to design or arrange the counterpart 14′ with a play between the surfaces 122′, 141′ of the door panel mount 12′ and the counterpart 14′, such that do not contact each other while still allowing the door panel 22 to be pivoted and hindering the door panel 22 to be lifted off from the door panel mount 12′.

### LIST OF REFERENCE NUMERALS

1, 1′ mounting device

11 attaching element

110 receptacle

12, 12′ door panel mount

120 support portion

121, 121′ lower portion

122, 122′ gliding surface

123 recess

124 guide rail

125 play

126 upper portion

127 outer surface

13 pivot joint

14, 14′ counterpart

141, 141′ gliding surface

142 protrusion

143 opening

144 fastening element

15 adjusting device

151 bolt

152 adjusting element

153 counter nut

154 screw head

155 opening

2 door

21 door window

22 door panel

220 upper portion

221 opening

222 upper edge

223 inner surface

224 play

3 wagon

31 wagon body

32 wagon window

33 carrier, connection element

330 rolling element

α1, α2, α3 angle

A attaching direction

P pivot axis

S swivel axis

V vertical axis

1. A mounting device for connecting a door panel to a door connection element, comprising
a door panel mount horizontally slideable on the door connection element and having a support portion, and
an attaching element, which is connectable with the door panel and is to be attached to the support portion of the door panel mount for mounting the door panel on the door panel mount,
wherein
the support portion of the door panel mount and the attaching element when being attached to one another together form a pivot joint for a pivotable connection of the door panel with the door connection element, wherein the pivot joint defines a pivot axis and the attaching element is attachable to the support portion of the door panel mount in an attaching direction having a directional component vertical to the pivot axis.

2. The mounting device according to claim 1, wherein the pivot axis is aligned substantially parallel to the plane of the door panel and substantially horizontal when the mounting device is in use.

3. The mounting device according to claim 1, wherein the support portion of the door panel mount has a substantially circular cross section or a cross section with a convex part.

4. The mounting device according to claim 1, wherein the support portion of the door panel mount has an elongate form and the attaching element has an elongate receptacle, wherein the attaching element is attachable to the support portion of the door panel mount by hanging the attaching element on the support portion of the door panel mount such that the receptacle of the attaching element receives the support portion of the door panel mount.

5. The mounting device according to claim 1, further comprising a counterpart for preventing a lift-off of the attaching element from the support portion of the door panel mount.

6. The mounting device according to claim 5, wherein the counterpart is to be fixed to the door panel.

7. The mounting device according to claim 5, wherein the counterpart is arranged adjacent to a portion of the door panel mount which is located on a side of the door panel mount opposite the support portion.

8. The mounting device according to claim 5, wherein the counterpart comprises a gliding surface which may glide along a corresponding gliding surface of the door panel mount when the door panel is pivoted about the pivot axis.

9. The mounting device according to claim 5, wherein the door panel mount comprises a recess which is engaged by a protrusion of the counterpart.

10. The mounting device according to claim 1, wherein the support portion of the door panel mount is formed in one piece with the door panel mount.

11. The mounting device according to claim 1, wherein the attaching element is arranged on an upper portion of the door panel.

12. The mounting device according to claim 1, further comprising an adjusting device for swiveling the door panel about a swivel axis substantially vertical to the plane of the door panel.

13. The mounting device according to claim 12, wherein the adjusting device has a bolt engaging an opening of a counterpart and an adjusting element engaging an opening of the door panel, wherein the adjusting element serves to swivel the door panel about the swivel axis.

14. A method for mounting a door panel to a door connection element by means of a mounting device having a door panel mount being horizontally slidable on the door connection element and having a support portion, and an attaching element being connectable with the door panel and the support portion of the door panel mount for mounting the door panel on the door panel mount,
wherein
the attaching element is attached to the support portion of the door panel mount in an attaching direction, wherein the support portion of the door panel mount and the attaching element when being attached to one another together form a pivot joint for a pivotable connection of the door panel with the door connection element, wherein the pivot joint defines a pivot axis having a directional component vertical to the attaching direction.

15. A door for a wagon, comprising at least one mounting device according to claim 1.

16. A wagon, comprising at least one mounting device according to claim 1.
